(19) United States
(12) Patent Application Publication
(10) Pub. No.: US 2011/0296468 A1
(43) Pub. Date: Dec. 1, 2011

(54) AUGMENTING TELEVISION MEDIA

(75) Inventors: Bradley R. Pettit, Los Gatos, CA (US); Marilyn Chen, Palo Alto, CA (US); Eric R. Soldan, Saratoga, CA (US)

(73) Assignee: MICROSOFT CORPORATION, Redmond, WA (US)

(21) Appl. No.: 12/791,770

(22) Filed: Jun. 1, 2010

(51) Int. Cl. H04N 7/173; H04N 7/16

(52) U.S. Cl. 725/62; 725/110

(57) ABSTRACT

This document describes techniques for, and apparatuses capable of, augmenting television media through a mobile computing device and/or a television-capable computing device. In one embodiment, a user's mobile computing device receives an event associated with a particular program of television media from the television-capable computing device, and, using this event, augments that television media through the mobile computing device with information associated with this event.

### BACKGROUND

In the not-too-distant past television was constrained to cathode-ray-tube sets displaying broadcast programming Viewers of this broadcast media could manually control the media in simple ways—by turning the channel or adjusting the volume. Over time remote controls were developed, which allowed these same adjustments to be made remotely, but this was still just simplistic control.

With the advent of cable and satellite television, basic information about television media became available through the television. Viewers could select a television guide, usually displayed on a particular channel, and by scrolling through the guide learn what television programs are or would be on, their titles, and sometimes descriptions of them.

More recently, control over and information about television media has expanded through the use of more-advanced set-top boxes and their remote controls. These remote controls and set-top boxes often permit viewers to record, fast forward, reverse, and pause television, as well as permit display of basic information about a television program while the program plays on screen. While these devices offer some additional information and control of television programs, they remain quite limited.

### SUMMARY

This document describes techniques for, and apparatuses capable of, augmenting television media through a mobile computing device and/or a television-capable computing device. In one embodiment, a user's mobile computing device receives an event associated with a particular program of television media from the television-capable computing device, and, using this event, augments that television media through the mobile computing device with information associated with this event.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit of a reference number identifies the figure in which the reference number first appears. The use of the same reference number in different instances in the description and the figures may indicate similar or identical items.

FIG. 1 is an illustration of an environment for augmenting television media.

FIG. 2 is an illustration of a detailed example of the television-capable computing device of FIG. 1.

FIG. 3 is an illustration of a detailed example of the mobile computing device of FIG. 1.

FIG. 4 is a flow diagram depicting an example process for augmenting television media at least in part using a display of a television-capable computing device.

FIG. 5 is a flow diagram depicting an example process for augmenting television media at least in part using a display of a mobile computing device.

### DETAILED DESCRIPTION

### Example Environment

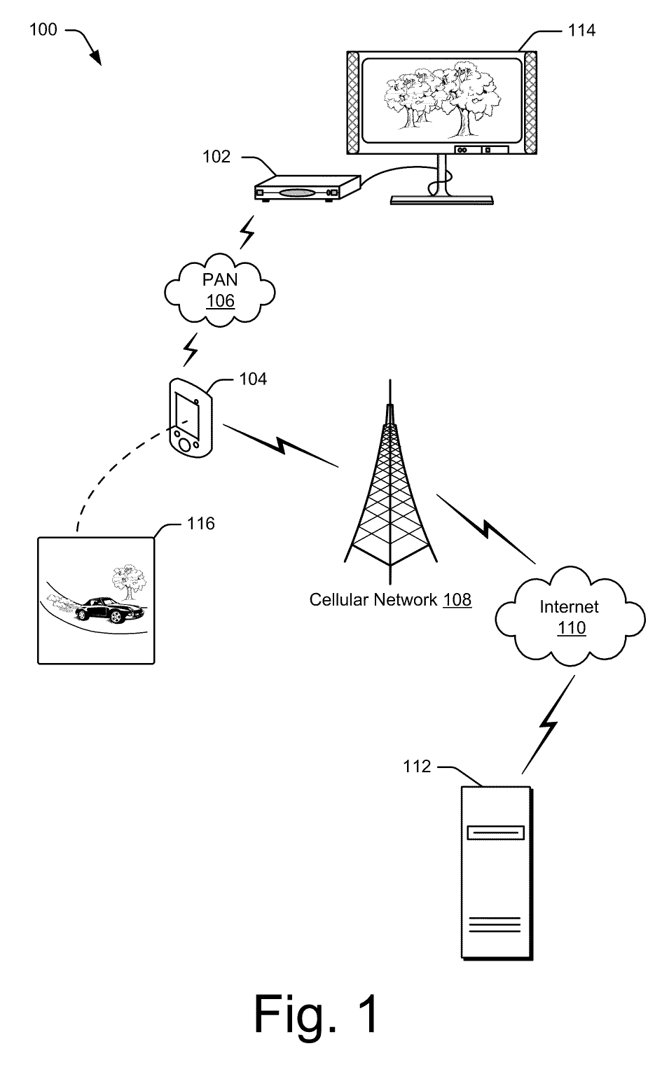

FIG. 1 is an illustration of an environment 100 in which techniques for augmenting television media can operate. Environment 100 includes a television-capable computing device 102, a mobile computing device 104, a personal area network (PAN) 106, a cellular network 108, the Internet 110, and a remote source 112. Television-capable computing device 102 and mobile computing device 104 are shown as a set-top box and smart phone, respectively, though other devices instead can be used. Environment 100 also includes two displays 114 and 116 through which television-capable computing device 102 and mobile computing device 104 display media and/or information, respectively.

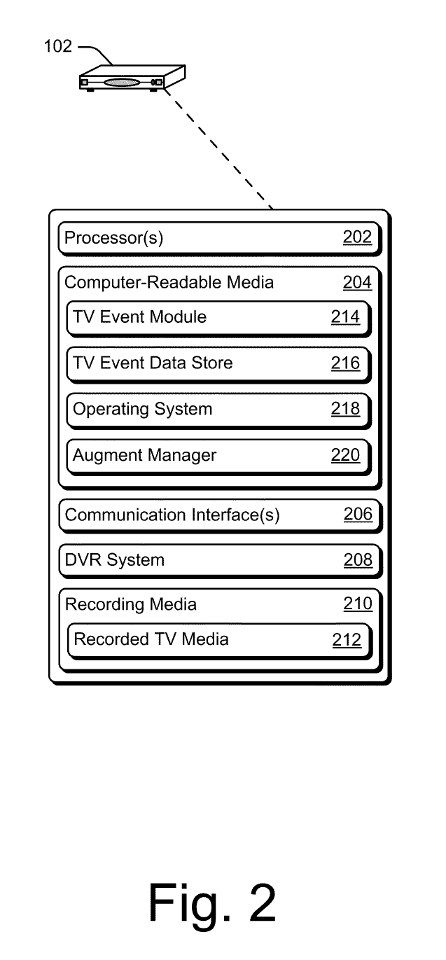

FIG. 2 illustrates a more-detailed embodiment of television-capable computing device 102. As shown in FIG. 2, television-capable computing device 102 includes processor(s) 202, computer-readable media 204, communication interface(s) 206, digital video recorder (DVR) system 208, and recording media 210 having recorded television media 212. Computer-readable media 204 includes or has access to television (TV) event module 214, television (TV) event data store 216, operating system 218, and augment manager 220. While television-capable computing device 102 is illustrated as a set-top box, other computing devices, such as a personal computer or gaming device, may instead be used.

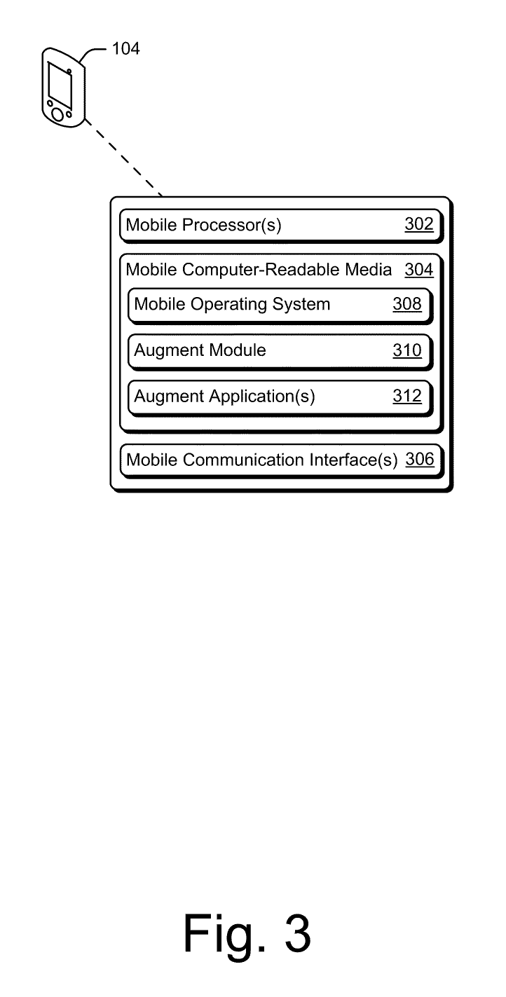

FIG. 3 illustrates a more-detailed embodiment of mobile computing device 104, including mobile processor(s) 302, mobile computer-readable media 304, and mobile communication interface(s) 306. Mobile computer-readable media 304 includes or has access to mobile operating system 308, augment module 310, and one or more augment application(s) 312. While mobile computing device 104 is illustrated as a smart phone, other computing devices, such as a network-capable remote control, netbook, or tablet computer may instead be used.

Note that one or more of the entities shown in FIGS. 1-3 may be further divided, combined, and so on. Generally, any of the functions described herein can be implemented using software, firmware, hardware (e.g., fixed-logic circuitry), manual processing, or a combination of these implementations. The terms “application,” “system,” “manager,” and “module,” as used herein generally represent software, firmware, hardware, whole devices or networks, or a combination thereof. In the case of a software implementation, for instance, these terms may represent program code that performs specified tasks when executed on a processor (e.g., CPU or CPUs). The program code can be stored in one or more computer-readable memory devices, such as computer-readable media 204 or 304.

Example Processes for Augmenting Television Media

The following discussion describes processes for augmenting television media. Aspects of these processes may be implemented in hardware, firmware, software, or a combination thereof. These processes are shown as sets of blocks that specify operations performed, such as through one or more entities of FIGS. 1, 2, and/or 3, and are not necessarily limited to the order shown for performing the operations by the respective blocks. In portions of the following discussion reference may be made to environment 100 of FIG. 1 as well as detailed embodiments of entities of FIG. 1 illustrated in FIGS. 2 and 3, though these are not necessarily required.

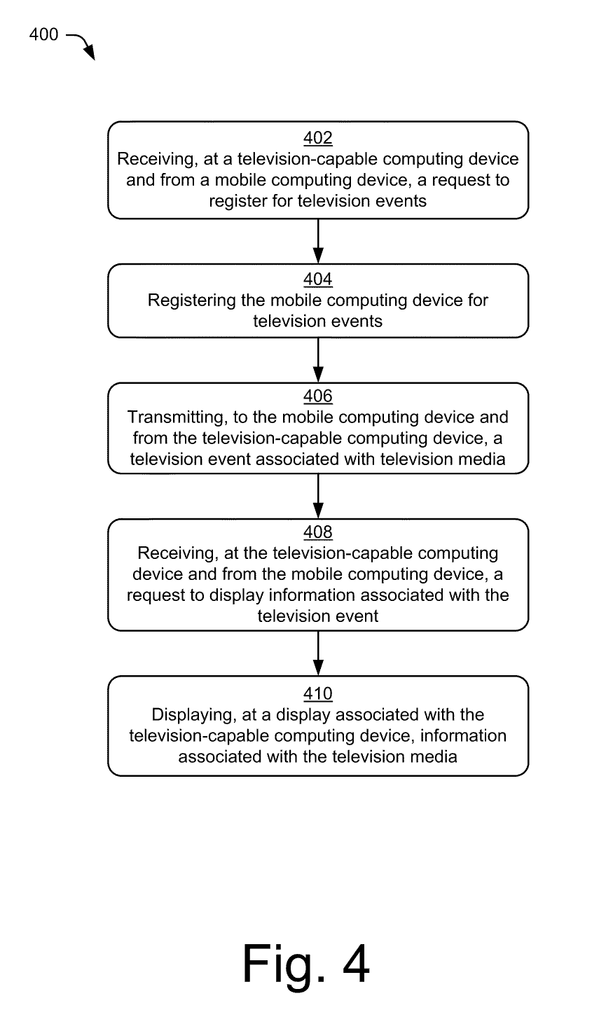

FIG. 4 is a flow diagram depicting an example process 400 for augmenting television media. This process 400 is directed to augmenting television media using a display associated with a television-capable computing device.

Block 402 receives, at a television-capable computing device and from a mobile computing device, a request to register for television events. In the context of environment 100, this registration informs television-capable computing device 102 that mobile computing device 104 would like to receive a notification when an event is triggered or otherwise received or generated by television-capable computing device 102.

By way of example, consider process 400 in the context of FIGS. 2 and 3. In this context, augment manager 220 receives, through personal area network 106 and using communication interfaces 206, a request to register for television events.

Block 404 registers the mobile computing device for the requested television events. Continuing the ongoing example, augment manager 220 registers these events with television event module 214 or internally if augment manager 220 receives and handles transmission of television events from television event module 214. To complete this registration, augment manager 220 uses information about mobile computing device 104 and the requested events. The information about mobile computing device 104 may include a unique identifier or other manner in which to differentiate it from other mobile devices.

The requested events can include many different types and the request can be received responsive to various situations. For example, the request at block 402 may be responsive to television-capable computing device 102 displaying a television show. Assume that the television show is a cooking show by the late Julia Child, and, responsive to seeing this television show, a user selects, through mobile computing device 104, to augment this television program. Mobile computing device 104 requests television events associated with this program, which is received at block 402 by television-capable computing device 102, after which augment manager 220 registers mobile computing device 104 for television events associated with Julia Child's cooking program.

As noted, television events can be of many types and be generic to numerous applications capable of consuming them. In this example one television event is an identifier uniquely identifying this particular program, entitled “French Crêpes.” Other events can occur at particular points in the program, such as an event associated with a recipe for a particular crêpe being momentarily displayed on the program. Still other events occur when a particular advertisement is shown or a product is displayed or discussed within the program.

As an aside, events that occur at a point in the program can be triggered from within the media stream from which the program and advertisements are rendered. This trigger is received by television event module 214. Television event module 214 and/or augment manager 220 may also generate an event responsive to a state change of television-capable computing device 102, responsive to analyzing the program or events of the program, or based on a viewer's history or preference in conjunction with information about the television media displayed. For example, augment manager 220 may receive a trigger indicating an advertisement has begun from television event module 214 and, in conjunction with a viewer's history of fast-forwarding advertisements, generate an event consumable by an advertisement-skipping application.

Block 406 transmits a television event to the mobile computing device. This transmission can be directly responsive to receiving or determining an event (e.g., receiving a trigger in a media stream) or otherwise. Thus, in some cases transmission is directly responsive to actions or determinations at television-capable computing device 102 and in other cases also responsive to further interaction with mobile computing device 104. For example, mobile computing device 104 may poll or “ping” television-capable computing device 102 at various times or responsive to determining that a trigger is likely to have occurred, after which television-capable computing device 102 transmits the television event.

In the ongoing context, however, no such further interaction with mobile computing device 104 is made. Here augment manager 220 or television event module 214 transmits a television event across personal area network 106 using communication interface 206 responsive to an internal determination that a television event has occurred.

This transmitted television event includes information usable by a mobile computing device 104. Continuing the Julia Child example, assume that an event uniquely identifying the French Crêpes program is transmitted. Using this information, mobile computing device 104 may retrieve applications and/or information with which to augment this program.

In this particular example, mobile computing device 104 directs television-capable computing device 102 in how to augment this program through display 114 shown in FIG. 1. Here assume that a user of mobile computing device 104 is presented with augment options, such as to display or save a textual representation of the recipes of the program, information about Julia Child and her life, or additional programs associated with French crêpes, cooking shows in general, or Julia Child, to name a few. For this example we assume that the user selects to display and save a textual representation of one of the recipes in the program.

Block 408 receives a request to display (or save) information associated with the television event. In the context of FIG. 2, augment manager 220 receives this request across personal area network 106 and using communication interface 206.

If the requested information is not immediately available to augment manager 220, augment manager 220 may retrieve this information in various manners, such as through a remote source via the Internet or some other network (not shown). Here assume that augment manager 220 retrieves this information from television events data store 216. In the case of media being requested, such as additional programs associate with Julia Child, augment manager 220 retrieves this media from remote source 112 or using DVR system 208 in conjunction with recording media 210 and possibly, if the media is already saved locally, recorded television media 212.

Block 410 displays information associated with the television media effective to augment the television media. Continuing the ongoing example and in the context of FIG. 2, augment manager 220 displays on a portion of display 114 a textual representation of the recipe. Augment manager 220 may also or instead save this textual representation of the recipe locally for later use.

Consider, by way of another example, a television event triggered by an advertisement displayed during the program, such as an advertisement for a movie about Julia Child (“Julie and Julia”) triggered within the media stream received by television-capable computing device 102. Television-capable computing device 102 transmits a television event identifying this advertisement. Assume that mobile computing device 104 receives this event, presents options for selection by a user through mobile computing device 104, and receives a selection to display a one-minute movie trailer for this movie. Augment manager 220 retrieves this media and then displays this trailer while suspending the French Crêpes program (or an advertisement being played). As is readily apparent, Julia Child's French Crêpes program is augmented by a textual representation of the recipe and the programs accompanying advertisement is augmented with display of a full movie trailer.

Operations set forth as part of process 400 can be repeated. A second mobile computing device or application on that device, for example, may register for the same or other television events. A mother of a household may wish to register for television events associated with cooking programs, a father may wish to register for television events associated with sports programs, and so forth for other members of the family. If each of these members of the family has a different mobile computing device or a way in which to be differentiated on a same mobile computing device, each of them may receive events for different types of programs.

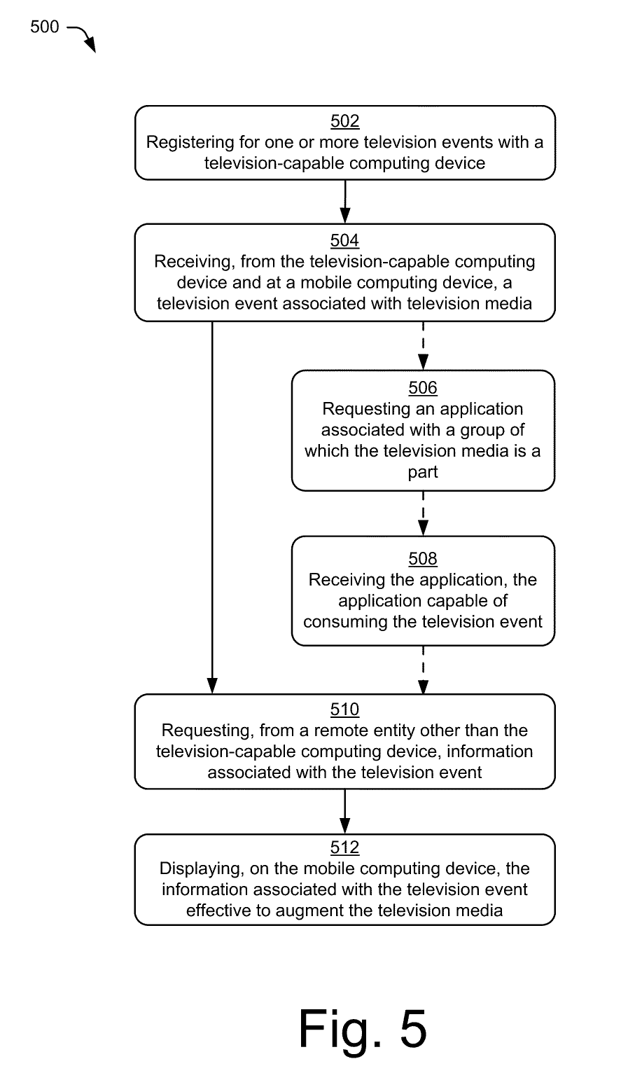

FIG. 5 is a flow diagram depicting an example process 500 for augmenting television media. This process 500 is directed to augmenting television media using a mobile computing device's display.

Block 502 registers for one or more television events with a television-capable computing device. This registration may be performed by mobile computing device 104 with television-capable computing device 102 or a third party. Even if the registration is performed between mobile computing device 104 and television-capable computing device 102, this registration may occur indirectly, such as through cellular network 108 and Internet 110. If with a third party, the registration may be with a remote entity, such as remote source 112.

In the context of FIGS. 2 and 3, augment module 310 requests one or more television events associated with a particular television media (e.g., program), groups of television media, or more-generalized television events, such as a state-change event associated with a channel change on the television-capable computing device 102. As noted above, the registration can be through a personal area network or other network, here using mobile communication interface 306.

For this example, assume that mobile computing device 104 requests to register for television events associate with sports programs, such as football, baseball, and basketball. Selection of these types of events may be made through a user interface provided by augment module 310 or through a particular augment application 312. Example television events for sports programs include sports plays made during the program that have a trigger in the media stream, advertisements displayed in the program or played during breaks in the program, and the like. Information about these events include statistics about particular players or teams, betting lines, fantasy sports points or other effects caused by the program's game, and other television media programs providing commentary either prior to, after, or during the game.

Block 504 receives a television event associated with television media. As noted above this can be with or without interaction from mobile computing device 104, such as a poll or ping for a television event. In the current context, augment module 310 of mobile computing device 104 receives a television event from augment manager 220 on the television-capable computing device 102 without polling or pinging by mobile computing device 104. Assume that the television event is associated with a particular player on a football team scoring a touchdown.

Process 500 alternatively proceeds to block 506 and block 508 or directly to block 510. Block 506 requests an application associated with a group of which the television media is a part. Block 508 receives the application capable of consuming the television event. For example, if the television event requested by augment module 310 is associated with a professional football game, augment module 310 may download an augment application capable of consuming television events from a professional football game. This augment application, illustrated as one of augment applications 312 in FIG. 3, may be generic or directed to a particular sport's league or team. Assume here that the augment application is directed to the National Football League and to the Green Bay Packers.

Block 510 requests, from a remote entity other than the television-capable computing device, information associated with the television event. Assume that the television event is a simple unique identifier. With this identifier, augment module 310 or augment application 312 requests, from remote source 112 via Internet 110 and cellular network 108, information associated with that unique identifier. This information is received and indicates that the television event is associated with a rushing touchdown by quarterback Aaron Rodgers starting at the 20-yard line.

Block 512 displays information associated with the television event effective to augment the television media. Continuing this example, augment application 312 plays the Green Bay Packers' song through a speaker on mobile computing device 104 and displays on display 116 of FIG. 1 statistics about Aaron Rodgers and fantasy football points generated by his touchdown.

The techniques described herein contemplate many types of television media, television events, and ways in which to augment these television media. In addition to those described above these techniques can be applied liberally including those associated with television media classified as drama, for children, comedy, and subject to parental controls. For example, a television event can be associated with any R-rated program or triggering event for violence, language, or nudity in an otherwise unrated or not R-rated program. A mobile computing device can then receive this event, such as a smart phone used by a parent. An augment application on the parent's mobile computing device can then display information about the program to the parent. This event may be received through a cellular, wireless local area network (WLAN), or other network even if the parent is not near the television-capable computing device. The parent could then, through the mobile computing device, control the television-capable computing device either locally or from a substantial distance. This is but one additional example of the many ways in which these techniques and apparatuses augment television media.

### CONCLUSION

This document describes techniques and apparatuses for augmenting television media. These techniques and apparatuses enable a user to enjoy extensive control, interaction with, and augmentations to television media. Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, at a television-capable computing device and from a mobile computing device, a request to register for one or more television events associated with television media;
registering the mobile computing device for the one or more television events;
transmitting, to the mobile computing device and from the television-capable computing device, a television event of the one or more television events;
receiving, at the television-capable computing device and from the mobile computing device, a request to display information associated with the television event; and
displaying the information at a display associated with the television-capable computing device.

2. The method as recited in claim 1, wherein the display also shows the television media and the act of displaying displays the information on the display concurrently with the television media.

3. The method as recited in claim 1, wherein the display also shows the television media and further comprising suspending the television media on the display prior to the act of displaying, and wherein the act of displaying displays the information during the act of suspending.

4. The method as recited in claim 1, wherein the one or more television events are generic to multiple applications capable of consuming the one or more television events.

5. The method as recited in claim 1, further comprising:
receiving, at the television-capable computing device and from a second mobile computing device, a second request to register for second television events;
registering the second mobile computing device for the second television events;
transmitting a second television event of the second television events to the second mobile computing device;
receiving a second request to display second information associated with the second television event; and
displaying, at the display, the second information.

6. The method as recited in claim 1, wherein the television media is a television program or an advertisement playing on the television-capable computing device.

7. The method as recited in claim 1, wherein the one or more television events include a television event triggered during a media stream for the television media, the media stream received at the television-capable computing device.

8. The method as recited in claim 1, wherein the one or more television events include a television event generated responsive to a state change on the television-capable computing device.

9. The method as recited in claim 1, wherein the one or more television events include a television event having a unique identifier identifying the television media as a particular television program.

10. The method as recited in claim 1, wherein the one or more television events include a television event identifying the television media as belonging to a group of media of which an augment application is capable of consuming.

11. The method as recited in claim 1, wherein the television-capable computing device is a set top box, a gaming console, or a computing device having access to streaming media.

12. The method as recited in claim 1, wherein the information about the television media includes second television media associated with the television media or textual information associated with the television media.

13. A method comprising:
receiving, from a television-capable computing device and at a mobile computing device, a television event associated with television media;
requesting, from a remote entity other than the television-capable computing device, information associated with the television event; and
displaying, on the mobile computing device, the information associated with the television event effective to augment the television media.

14. The method as recited in claim 13, further comprising, prior to the act of requesting information associated with the television event:
requesting an application associated with a group of which the television media is a part, the application capable of consuming the television event; and
receiving the application,
wherein the application performs the acts of requesting the information and displaying the information.

15. The method as recited in claim 14, wherein the television event is generic to the application and multiple other applications.

16. The method as recited in claim 13, wherein the mobile computing device is a smart phone and the act of requesting information requests the information through a cellular network.

17. The method as recited in claim 13, wherein the act of displaying the information is performed on a first display of the mobile computing device concurrently with displaying of the television media on a second display associated with the television-capable computing device.

18. The method as recited in claim 13, wherein the television media is a television program or an advertisement playing on the television-capable computing device.

19. The method as recited in claim 13, wherein the one or more television events is received at the television-capable computing device within a data stream for the television media.

20. The method as recited in claim 13, wherein the mobile computing device is a smart phone capable of communicating with one or more remote sources accessible through the internet and from which the information associated with the television event is received.
